(19) United States
(12) Patent Application Publication
(10) Pub. No.: US 2016/0125769 A1
(43) Pub. Date: May 5, 2016

(54) PET IDENTIFICATION ASSEMBLY

(71) Applicants: Teresa Cox, Florence, AL (US); Adalberto Giron-Pagan, Florence, AL (US)

(72) Inventors: Teresa Cox, Florence, AL (US); Adalberto Giron-Pagan, Florence, AL (US)

(21) Appl. No.: 14/527,086

(22) Filed: Oct. 29, 2014

(51) Int. Cl. G09F 3/20; A45C 13/00; B65D 25/54; A45C 11/24; G09F 3/02; B65D 25/20

(52) U.S. Cl. CPC G09F 3/201; G09F 3/02; B65D 25/205; B65D 25/54; A45C 11/24; A45C 13/005; G09F 2003/0279

(57) ABSTRACT

A pet identification assembly includes a case that may be transported with a pet. The case is structured to have a first section hingedly coupled to a second section such that the case is positionable in an open positioned and a closed position. Each of a plurality of cards contains information about the pet to allow an observer to properly care for the pet. Each of a plurality of first holders is coupled to the first section. Each of the first holders receives associated ones of the cards to display the cards to an observer. Each of a pair of second holders is coupled to the second section. Each of the second holders receives associated ones of the cards to display the cards to the observer.

### BACKGROUND OF THE DISCLOSURE

### Field of the Disclosure

The disclosure relates to identification devices and more particularly pertains to a new identification device for allow a pet to be properly cared for if the pet is lost during travel or other similar occasion.

### SUMMARY OF THE DISCLOSURE

An embodiment of the disclosure meets the needs presented above by generally comprising a case that may be transported with a pet. The case is structured to have a first section hingedly coupled to a second section such that the case is positionable in an open positioned and a closed position. Each of a plurality of cards contains information about the pet to allow an observer to properly care for the pet. Each of a plurality of first holders is coupled to the first section. Each of the first holders receives associated ones of the cards to display the cards to an observer. Each of a pair of second holders is coupled to the second section. Each of the second holders receives associated ones of the cards to display the cards to the observer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a pet identification assembly according to an embodiment of the disclosure.

FIG. 2 is a back perspective view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a front view of an embodiment of the disclosure.

### DESCRIPTION OF THE PREFERRED EMBODIMENT

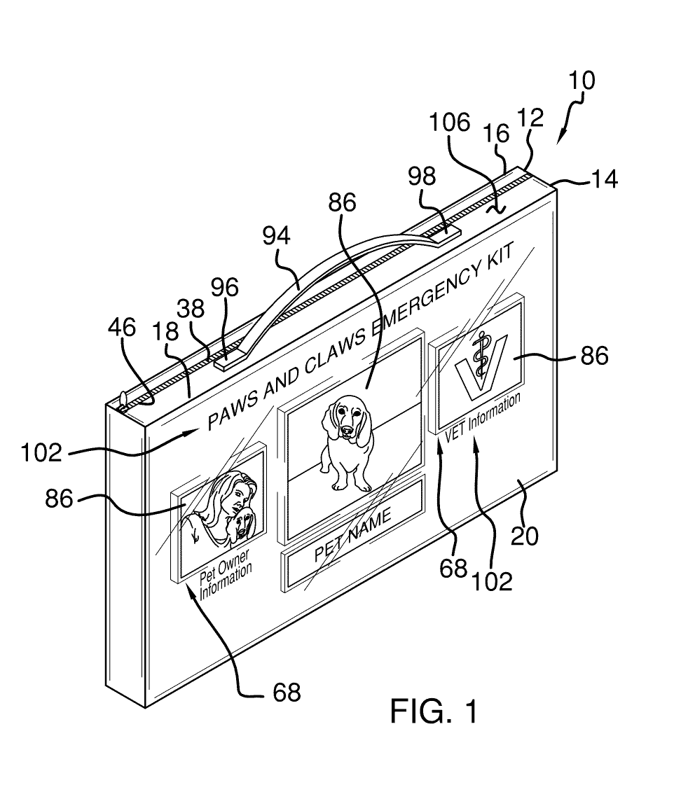

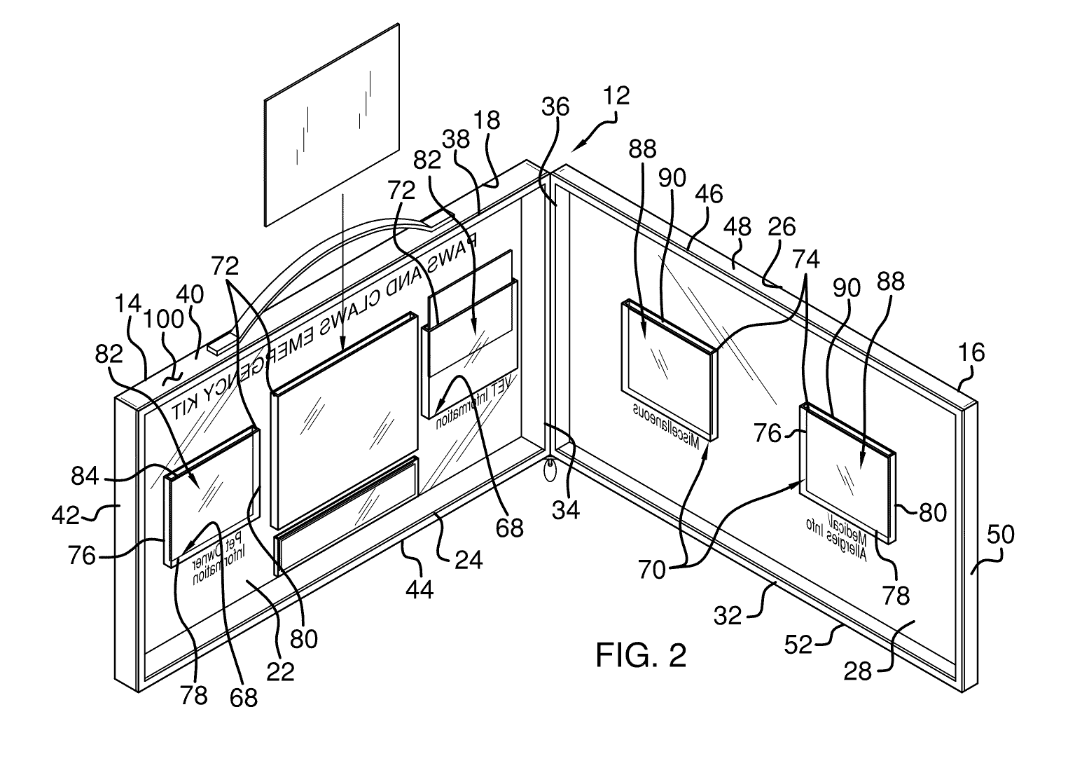

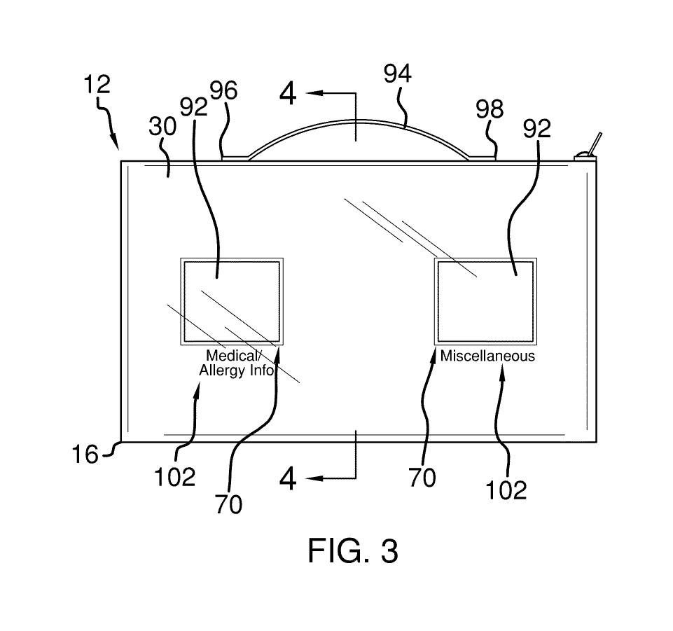

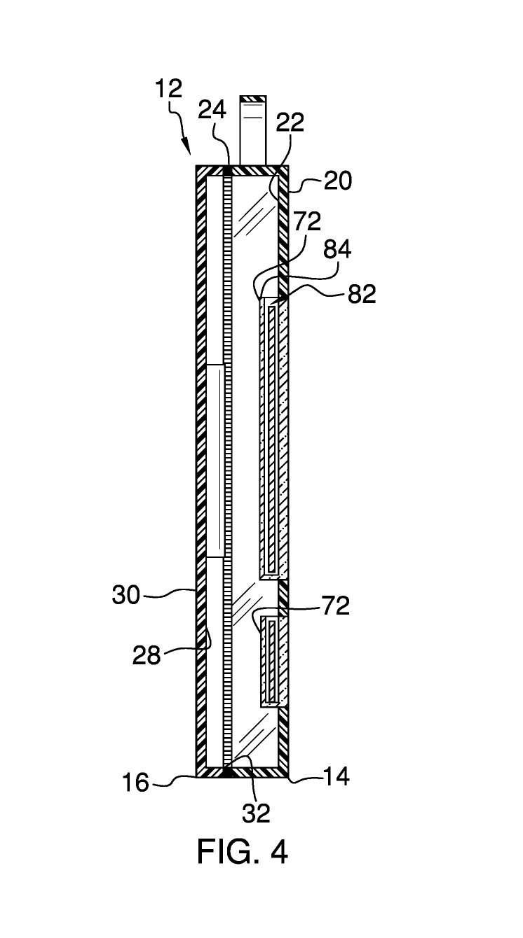

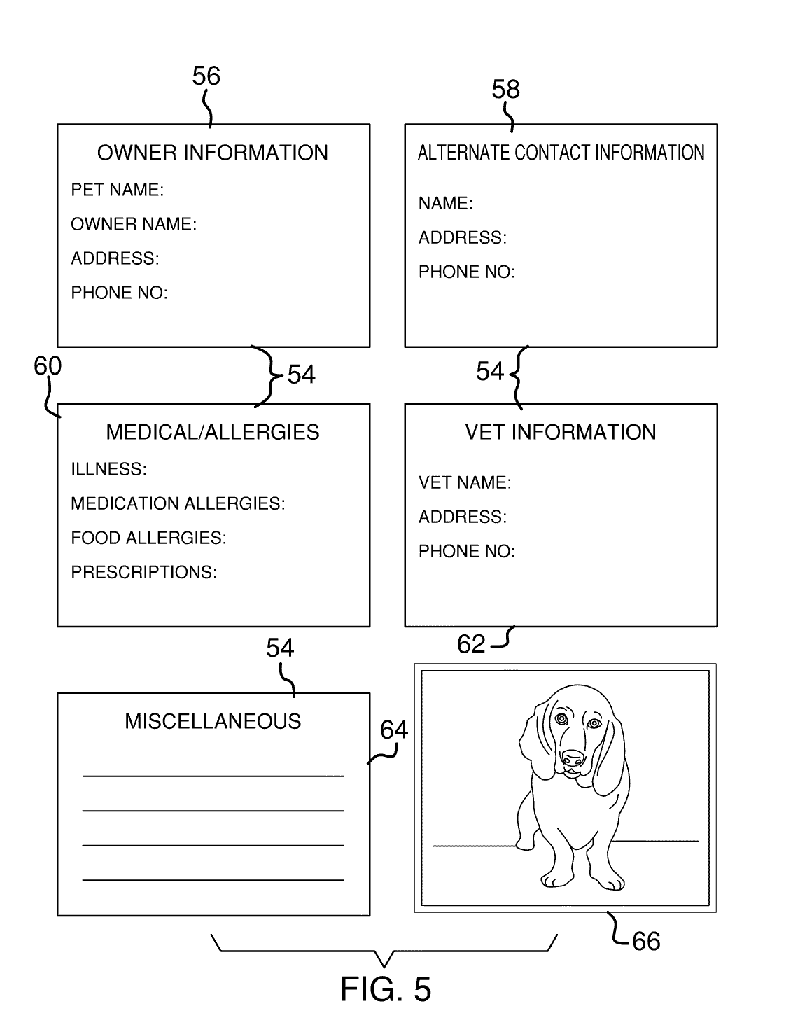

With reference now to the drawings, and in particular to FIGS. 1 through 5 thereof, a new identification device embodying the principles and concepts of an embodiment of the disclosure and generally designated by the reference numeral 10 will be described.

As best illustrated in FIGS. 1 through 5, the pet identification assembly 10 generally comprises a case 12 that may be transported with a pet. The pet may be dog or a cat or the like. The case 12 is structured to have a first section 14 hingedly coupled to a second section 16 such that the case 12 is positionable in an open positioned and a closed position. The case may be comprised of a fluid impermeable material.

The first section 14 has an outer edge 18 extending between each of a front side 20 and a back side 22 of the first section 14. A first lip 24 is coupled to and extends rearwardly from the back side 22 such that the first lip 24 is coextensive with the outer edge 18. The second section 16 has an exterior edge 26 extending between each of a forward side 28 and a rearward side 30 of the second section 16. A second lip 32 is coupled to and extends forwardly from the forward side 28 such that the second lip 32 is coextensive with the exterior edge 26. A first lateral side 34 of the first lip 24 is hingedly coupled to a first flanking side 36 of the second lip 32.

A first coupler 38 is coupled to each of a top side 40, a second lateral side 42 and a bottom side 44 of the first lip 24. A second coupler 46 is coupled to each of an upper side 48, a second flanking side 50 and a lower side 52 of the second lip 32. The first coupler 38 engages the second coupler 46 to retain the case 12 in the closed position. The first coupler 38 and the second coupler 46 may be a zipper or the like.

A plurality of cards 54 is provided. Each of the cards 54 contains information about the pet. The cards 54 may comprise an owner information card 56, an alternate contact information card 58, a medical/allergies card 60, a vet information card 62, a miscellaneous card 54 and a pet image card 66 or other similar information. The pet image card 66 may display an image of the pet.

The first section 14 has a plurality of first openings 68 extending through the front side 20 and the back side 22. The first openings 68 may be evenly spaced apart and distributed laterally along the first section 14. The second section 16 has a pair of second openings 70 extending through the forward side 28 and the rearward side 30. The second openings 70 may be evenly spaced apart and distributed laterally along the second section 16. A plurality of first holders 72 and a pair of second holders 74 are provided. Each of the first holders 72 and the second holders 74 has a respective first lateral edge 76, a respective bottom edge 78 and a respective second lateral edge 80.

The first lateral edge 76, the second lateral edge 80 and the bottom edge 78 of each of the first holders 72 is coupled to the back side 22 to define a first pocket 82 with an open top end 84. Each of the first holders 72 is aligned with an associated one of the first openings 68. The top end 84 of each of the first pockets 82 receives associated ones of the cards 54 to display the cards 54 to an observer. A plurality of first windows 86 is provided. Each of the first windows 86 is coupled to the front side 20 such that each of the first windows 86 completely covers an associated one of the first openings 68.

The first lateral edge 76, the second lateral edge 80 and the bottom edge 78 of each of the second holders 74 is coupled to the rearward side 30 to define a second pocket 88 with an open upper end 90. Each of the second holders 74 is aligned with an associated one of the second openings 70. The upper end 90 of each of the second pockets 88 receives associated ones of the cards 54 to display the cards 54 to the observer. The observer may read the information about the pet if the pet becomes lost or in the event of an emergency.

A pair of second windows 92 is provided. Each of the second windows 92 is coupled to the forward side 28 such that each of the second windows 92 completely covers an associated one of the second openings 70. A handle 94 has a first end 96 and a second end 98. Each of the first end 96 and the second end 98 are coupled to an outer surface 100 of the top side 40 of the first lip 24. The handle 94 may be gripped to carry the case 12.

Indicia 102 are printed on the front side 20 of the first section 14. The indicia 102 are aligned with each of the first openings 68. The indicia 102 may comprise the words “pet owner information”, “vet information” and “paws and claws emergency kit”. Indicia 102 are printed on the rearward side 30 of the second section 16. The indicia 102 are aligned with each of the second openings 70. The indicia 102 may comprise the words “medical/allergy info” and “miscellaneous”.

In use, each of the cards 54 is filled out with information pertaining to an associated one of the owner information card 56, the alternate contact information card 58, the medical/allergies card 60, the vet information card 62 and the miscellaneous card 64. Each of the cards 54 is positioned in an associated one of the first pockets 82 and the second pockets 88. The case 12 is carried during travel or other times when the pet is being transported. The assembly 10 ensures the pet can be properly cared for in the event of being lost or otherwise separated from the pet's owner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pet identification assembly comprising:
a case configured to be transported with a pet, said case being structured to have a first section hingedly coupled to a second section such that said case is positionable in an open positioned and a closed position;
a plurality of cards;
indicia positioned on said cards, said indicia indicating information related to the pet wherein each said card is configured for assisting in provision of proper medical care for the pet;
a plurality of first holders coupled to said first section, each of said first holders receiving associated ones of said cards wherein said first holders are configured to display said cards to the observer to facilitate the observer reading the information about the pet; and
a pair of second holders coupled to said second section, each of said second holders receiving associated ones of said cards wherein said second holders are configured to display said cards to the observer to facilitate the observer reading information about the pet.

2. The assembly according to claim 1, further comprising:
said first section having an outer edge extending between each of a front side and a back side of said first section, said first section having a first lip coupled to and extending rearwardly from said back side such that said lip is coextensive with said outer edge; and
said second section having an exterior edge extending between each of a forward side and a rearward side of said second section, said second section having a second lip coupled to and extending rearwardly from said rearward side such that said second lip is coextensive with said exterior edge, a first lateral side of said first lip being hingedly coupled to a first flanking side of said second lip.

3. The assembly according to claim 2, further comprising:
a first coupler coupled to each of a top side, a second lateral side and a bottom side of said first lip;
a second coupler coupled to each of an upper side, a second flanking side and a lower side of said second lip; and
said first coupler engaging said second coupler to retain said case in said closed position.

4. The assembly according to claim 2, further comprising said first section having a plurality of first openings extending through said front side and said back side, each of said first holders being coupled to said back side such that each of said holders is aligned with an associated one of said first openings.

5. The assembly according to claim 2, further comprising said second section having a pair of second openings extending through said forward side and said rearward side, each of said second holders being coupled to said rearward side such that each of said second holders is aligned with an associated one of said second openings.

6. The assembly according to claim 4, further comprising a plurality of first windows, each of said first windows being coupled to said front side such that each of said first windows completely covers an associated one of said first openings.

7. The assembly according to claim 5, further comprising a pair of second windows, each of said second windows being coupled to said forward side such that each of said second windows completely covers an associated one of said second openings.

8. A pet identification assembly comprising:
a case configured to be transported with a pet, said case being structured to have a first section hingedly coupled to a second section such that said case is positionable in an open positioned and a closed position;
said first section having an outer edge extending between each of a front side and a back side of said first section, said first section having a first lip coupled to and extending rearwardly from said back side such that said lip is coextensive with said outer edge;
said second section having an exterior edge extending between each of a forward side and a rearward side of said second section, said second section having a second lip coupled to and extending rearwardly from said rearward side such that said second lip is coextensive with said exterior edge, a first lateral side of said first lip being hingedly coupled to a first flanking side of said second lip;
a first coupler coupled to each of a top side, a second lateral side and a bottom side of said first lip;
a second coupler coupled to each of an upper side, a second flanking side and a lower side of said second lip;
said first coupler engaging said second coupler to retain said case in said closed position;
a plurality of cards;
indicia positioned on said cards, said indicia indicating information related to the pet wherein each said card is configured for assisting in provision of proper medical care for the pet;
said first section having a plurality of first openings extending through said front side and said back side;
said second section having a pair of second openings extending through said forward side and said rearward side;
a plurality of first holders, each of said first holders being coupled to said back side such that each of said first holders is aligned with an associated one of said first openings, each of said first holders receiving associated ones of said cards wherein said first holders are configured to display said cards to an observer to facilitate the observer reading the information about the pet;
a plurality of first windows, each of said first windows being coupled to said front side such that each of said first windows completely covers an associated one of said first openings;
a pair of second holders, each of said second holders being coupled to said rearward side such that each of said second holders is aligned with an associated one of said second openings, each of said second holders receiving associated ones of said cards wherein said second holders are configured to display said cards to the observer to facilitate the observer reading information about the pet; and
a pair of second windows, each of said second windows being coupled to said forward side such that each of said second windows completely covers an associated one of said second openings.
